(19) United States
(12) Patent Application Publication
(10) Pub. No.: US 2024/0175389 A1
(43) Pub. Date: May 30, 2024

(54) COOLING MODULE FOR AN ELECTRIC OR HYBRID MOTOR VEHICLE, HAVING A TANGENTIAL-FLOW TURBOMACHINE

(71) Applicant: VALEO SYSTEMES THERMIQUES, La Verriere (FR)

(72) Inventors: Amrid MAMMERI, La Verriere (FR); Kamel AZZOUZ, La Verriere (FR); Issiaka TRAORE, La Verriere (FR); Sebastien GARNIER, La Verriere (FR)

(73) Assignee: VALEO SYSTEMES THERMIQUES, La Verriere (FR)

(21) Appl. No.: 18/552,046

(22) PCT Filed: Mar. 22, 2022
(86) PCT No.: PCT/EP2022/057542

§ 371 Date: Sep. 22, 2023

(30) Foreign Application Priority Data
Mar. 25, 2021 (FR) FR2102981

(51) Int. Cl. F01P 5/06; B60K 11/04; F04D 17/04; F04D 25/06; F04D 29/056; F04D 29/42; F04D 29/58

(52) U.S. Cl. CPC F01P 5/06; B60K 11/04; F04D 17/04; F04D 25/06; F04D 29/056; F04D 29/4206; F04D 29/582

(57) ABSTRACT

Cooling module including a housing, configured to accept a tangential-flow turbomachine including a turbine with at least one stage of blades forming a hollow cylinder, the turbomachine also including a motor configured to drive the rotation of the turbine, the motor including a stator and a rotor mounted with the ability to rotate about the stator. The stator of the motor is secured to the housing in such a way that the blades of the turbine are arranged circumferentially around the rotor of the motor. The at least one stage of blades of the turbine is mechanically connected to the rotor of the motor so as to be driven in rotation thereby.

### TECHNICAL FIELD

The present invention relates to a cooling module for an electric or hybrid motor vehicle, having a tangential-flow turbomachine.

### BACKGROUND OF THE INVENTION

A cooling module (or heat-exchange module) of a motor vehicle conventionally comprises at least one heat exchanger and a ventilation device which is designed to generate a flow of air in contact with the at least one heat exchanger. The ventilation device makes it possible, for example, to generate a flow of air in contact with the heat exchanger, when the vehicle is stationary or running at low speed.

This ventilation device takes the form, for example, of a tangential-flow turbomachine comprising a turbine mounted rotatably about an axis of rotation and driven in motion by a motor. This motor is located in particular outside the housing of the cooling module comprising the tangential-flow turbomachine, which increases the overall dimensions of said module.

The space available within the motor vehicle for siting the cooling module, however, is relatively tight. A compact design of the cooling module should therefore be favored by optimizing the architecture of its components.

### BRIEF SUMMARY OF THE INVENTION

The aim of the present invention is therefore to at least partially overcome the disadvantages of the prior art and to propose a cooling module that is less bulky but maintains its efficiency.

The present invention therefore relates to a cooling module for a motor vehicle with an electric or hybrid motor, said cooling module being designed to have an airflow passing through it and comprising a housing configured to receive a tangential-flow turbomachine itself configured to generate the airflow, the tangential-flow turbomachine comprising a turbine mounted so as to rotate about an axis of rotation, the turbine comprising at least one stage of blades forming a hollow cylinder, the turbomachine also comprising a motor configured to drive the turbine in rotation about the axis of rotation, the motor comprising a stator and a rotor mounted rotatably about the stator, the stator of the motor being secured to the housing so that the turbine blades are arranged circumferentially around the rotor of the motor and such that the at least one blade stage of the turbine is mechanically connected to the rotor of the motor so as to be driven in rotation by the latter.

Such an arrangement of the motor within the turbomachine makes it possible to reduce the volume of the cooling module in the width direction of the motor vehicle, while maintaining ventilation performance. In fact, the flow of air within the turbine is tangential, thus creating a vortex at the center of the turbine, i.e. a space in which the airflow velocity is virtually zero. The turbomachine motor is located in this vortex, and therefore, a priori, it does not constitute an obstacle to the circulation of air within the turbomachine.

The invention can further comprise one or more of the following aspects taken alone or in combination:
the longitudinal axis of the motor rotor coincides with the axis of rotation of the turbine;
the rotor has arms which extend radially from the rotor to the turbine so as to secure the rotor to the turbine;
the radial arms connecting the rotor to the turbine are arranged at regular angular intervals around the axis of rotation of the turbine;
the longitudinal axis of the motor rotor and the axis of rotation of the turbine are offset;
the motor output shaft and the turbine are connected by a transmission mechanism configured to ensure the transmission of rotary motion between the motor output shaft and the turbine;
the stator is fixed to a plate secured to a side wall of the collector housing, so that the motor is located at one end of the turbine;
the turbine has several stages of blades aligned along the longitudinal axis of the turbine;
a longitudinal dimension of the motor is greater than the value of the motor diameter;
the turbine has a second end located opposite the first end and this second end has means for forming a direct pivot connection to the collector housing, and
the means for forming a direct pivot connection to the collector housing is a bearing or a rolling bearing located inside the collector housing.

### BRIEF DESCRIPTION OF THE DRAWINGS

Other characteristics and advantages of the present invention will become clearer from reading the following description, provided by way of non-limiting illustration, and from the appended drawings, in which:

FIG. 1 shows a schematic depiction of the front of a motor vehicle in side view;

FIG. 2 shows a schematic depiction in perspective and in partial cross-section of the front of a motor vehicle and of a cooling module,

FIG. 3 shows a cross-sectional view of the cooling module in FIG. 2; and

FIG. 4 shows a cross-sectional view of the housing of the cooling module in the plane of section A-A of FIG. 3.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Simple characteristics of different embodiments can also be combined and/or interchanged to provide other embodiments.

In the present description, some elements or parameters can be indexed, such as, for example, first element or second element, as well as first parameter and second parameter or also first criterion and second criterion, etc. In this case, the indexing is simply to differentiate between, and denote, elements or parameters or criteria that are similar, but not identical. This indexing does not imply any priority of one element, parameter or criterion over another and such denominations can easily be interchanged without departing from the scope of the present description. Nor does this indexing imply any chronological order, for example, in assessing any given criterion.

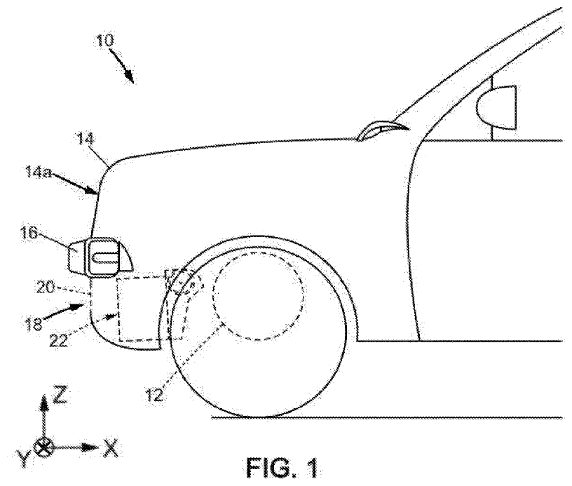

In FIGS. 1 to 4, a trihedron XYZ is shown in order to define the orientation of the various elements in relation to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

In all of the figures, the cooling module according to the present invention is illustrated in a functional position, i.e. when it is positioned within a motor vehicle.

FIG. 1 schematically illustrates the front part of an electric or hybrid motor vehicle 10 which can comprise an electric motor or hybrid engine 12. The vehicle 10 notably comprises a body 14 and a bumper 16 which are supported by a chassis (not depicted) of the motor vehicle 10. A cooling module 22 is positioned below the bumper 16 and facing the underbody of the motor vehicle 10. The body 14 optionally can define a cooling opening 18, that is, an opening through the body 14. This cooling opening 18 preferably faces the cooling module 22. A radiator grille 20 can optionally protect this cooling module 22.

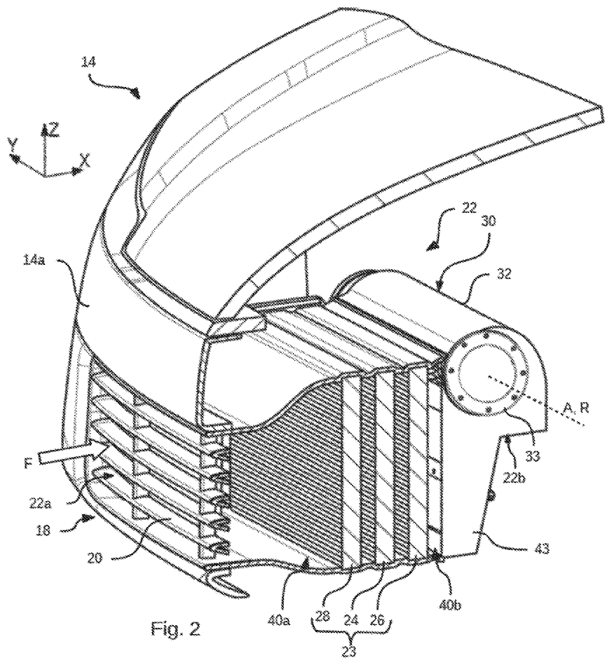

As shown in FIGS. 2 to 4, the cooling module 22 is designed to have an airflow F passing through it parallel to the direction X going from the front to the rear of the vehicle 10. The direction X corresponds more particularly to the longitudinal axis of the cooling module 22, and the airflow F circulates from an air inlet 22a to an air outlet 22b. In the present application, an element which is positioned further forward or rearward than another element is referred to respectively as being “upstream” or “downstream”, in the longitudinal direction X of the cooling module 22. The front corresponds to the front of the motor vehicle 10 in the assembled state, or to the face of the cooling module 22 through which the airflow F is intended to enter the cooling module 22. The rear, for its part, corresponds to the rear of the motor vehicle 10, or to that face of the cooling module 22 through which the airflow F is intended to leave the cooling module 22.

Similarly, “upper” and “lower” mean an orientation in the direction Z. A so-called upper element will be closer to the roof of the vehicle 10, and a so-called lower element will be closer to the ground.

The cooling module 22 substantially comprises fairing 40 forming an inner duct between an upstream end 40a and a downstream end 40b which are opposite one another. This inner duct is preferably oriented parallel to the direction X such that the upstream end 40a is oriented toward the front of the vehicle 10, opposite the cooling opening 18, and such that the downstream end 40b is oriented toward the rear of the vehicle 10.

According to the embodiments of the cooling module 22 shown in FIGS. 2 to 4, the fairing 40 forming the inner duct has four connecting walls 410, including a top wall 411 and a bottom wall 412, which are arranged opposite each other, and two side walls (not visible in the figures).

At least one heat exchanger 24, 26, 28 is positioned in the interior of said fairing 40. In FIGS. 2 to 4, the cooling module 22 comprises three heat exchangers 24, 26, 28 grouped together within a set of heat exchangers 23. However, it could comprise more or fewer depending on the desired configuration.

A first heat exchanger 24 can for example be configured to release heat energy from the airflow F. This first heat exchanger 24 can more particularly be a condenser connected to a cooling circuit (not represented), for example in order to cool the batteries of the vehicle 10. This cooling circuit can for example be an air-conditioning circuit able to cool the batteries and an internal flow of air destined for the motor vehicle interior.

A second heat exchanger 26 can also be configured to release heat energy into the airflow F. This second heat exchanger 26 can more particularly be a radiator which is connected to a heat control circuit (not depicted) for electrical elements, such as the electric motor 12.

Since the first heat exchanger 24 is generally a condenser of an air-conditioning circuit, the circuit needs the airflow F to be as “cool” as possible in air-conditioning mode. For this purpose, the second heat exchanger 26 is preferably positioned downstream from the first heat exchanger 24 in the direction of circulation of the airflow F. It is nevertheless entirely conceivable for the second heat exchanger 26 to be positioned upstream from the first heat exchanger 24.

The third heat exchanger 28 can for its part also be configured to release heat energy into the airflow. This third heat exchanger 28 can more particularly be a radiator connected to a heat control circuit (not represented), which can be separate from the one connected to the second heat exchanger 26, for electrical elements such as the power electronics. It is also entirely conceivable for the second 26 and the third 28 heat exchangers to be connected to a single heat control circuit, for example connected in parallel with one another.

Again according to the example illustrated in FIGS. 2 to 4, the second heat exchanger 26 is positioned downstream from the first heat exchanger 24, whereas the third heat exchanger 28 is positioned upstream from the first heat exchanger 24. Other configurations can nevertheless be envisaged, such as, for example, the second 26 and third 28 heat exchangers both positioned downstream or upstream from the first heat exchanger 24.

In the embodiment illustrated, each of the heat exchangers 24, 26, 28 has a generally parallelepiped form which is determined by a length, a thickness and a height. The length extends in the direction Y, the thickness extends in the direction X, and the height extends in the direction Z. The heat exchangers 24, 26, 28 thus extend on a general plane parallel to the vertical direction Z and the lateral direction Y. This general plane is thus perpendicular to the longitudinal direction X of the cooling module 22, and the heat exchangers 24, 26, 28 are therefore perpendicular to the airflow F which is intended to pass through them.

The cooling module 22 also comprises a collector housing 41 which is positioned downstream from the fairing 40 and the set 23 of heat exchangers 24, 26, 28. More specifically, the collector housing 41 is juxtaposed with the downstream end 40b of the fairing 40, and is thus aligned with the fairing 40 along the longitudinal axis X of the cooling module 22. The collector housing 41 comprises in particular the air outlet 22b intended to discharge the airflow F. The collector housing 41 can be integral with the fairing 40 or it can be an added-on part secured to the downstream end 40b of said fairing 40.

This collector housing 41 is configured to receive a tangential-flow turbomachine 30, itself configured in order to generate the airflow F passing through the set of heat exchangers 23. More particularly, the collector housing 41 can comprise a volute 44 at the center of which the tangential-flow turbomachine 30 is arranged, this volute 44 can at least partially delimit the air outlet 22b.

In the example illustrated in all of FIGS. 2 to 4, the tangential-flow turbomachine 30 is in a high position, notably in the upper third of the collector housing 41, preferably in the upper quarter of the collector housing 41. This notably makes it possible to protect the tangential-flow turbomachine 30 in the event of submersion, and/or to limit the space taken up by the cooling module 22 in its lower part. In this case, the air outlet 22b of the airflow F is preferably oriented towards the lower part of the cooling module 22.

It is nevertheless conceivable for the tangential-flow turbomachine 30 to be in a low position, notably in the lower third of the collector housing 41. This would make it possible to limit the space taken up by the cooling module 22 in its upper part. In this case, the air outlet 22b for the airflow would preferably be oriented towards the upper part of the cooling module 22. Alternatively, the tangential-flow turbomachine 30 can be in a median position, in particular in the median third of the height of the first collector housing 41, for example for reasons of integration of the cooling module 22 into its surroundings. These alternatives are not illustrated.

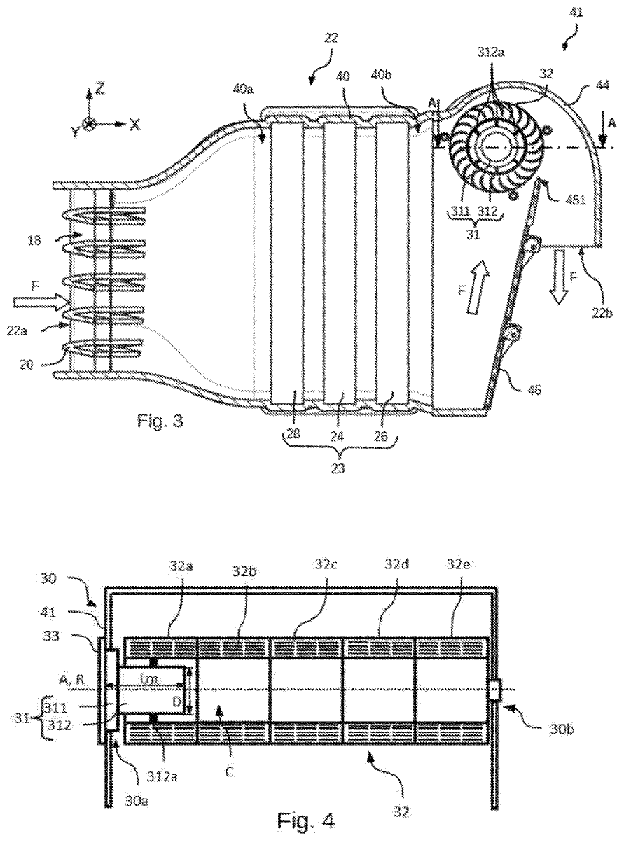

Taking the example shown in FIG. 3, the collector housing 41 has a guide wall 46, facing the downstream end 40b of the fairing 40, which makes it possible to guide the air leaving the set of heat exchangers 23 towards the outlet 22b. The guide wall 46 more particularly comprises an upstream edge 451 making it possible to delimit the outlet 22b for the airflow F in a complementary manner to the volute 44. Here, “upstream edge 451” means the edge of the air outlet 22b closest to the downstream end 40b of the fairing 40. The collector housing 41 thus makes it possible to recuperate the airflow F which passes through the set of heat exchangers 23, and to orient this airflow F towards the air outlet 22b, this notably being illustrated by the arrows indicating the airflow F in FIG. 3.

The tangential-flow turbomachine 30 arranged in the center of the volute 44 comprises a turbine 32 mounted rotatably about an axis of rotation A which is, for example, parallel to the Y direction, as illustrated in particular in FIG. 2. Turbine 32 is generally substantially cylindrical in shape and can comprise at least one blade stage 32a, 32b, 32c, 32d and 32e (FIG. 4). The term “blade stage” here means an arrangement of several blades that form a longitudinal portion of the turbine cylinder 32. Thus, a “blade stage” refers to several blades arranged parallel to each other on the lateral surface of said cylinder. The turbine 32 can comprise several blade stages 32a, 32b, 32c, 32d and 32e aligned along the longitudinal axis R of the turbine. The number of blade stages forming the turbine 32 can be between two and twelve. The turbine 32 shown schematically in FIG. 4, for example, comprises five blade stages 32a, 32b, 32c, 32d and 32e.

The tangential-flow turbomachine 30 also comprises a motor 31 (visible in FIGS. 2, 3 and 4) configured to drive the turbine 32 in rotation around the axis A, for example at a speed between 200 rpm and 14,000 rpm. In particular, this speed range makes it possible to limit the noise generated by the tangential-flow turbomachine 30 when in operation.

The motor 31 comprises a stator 311 secured to the housing 41 and a rotor 312 rotatably mounted around the stator 311. The stator 311 and the rotor 312 are arranged in such a way that the turbine blades 32 are arranged circumferentially around the rotor 312, as shown in greater detail in FIGS. 3 and 4. In this way, the motor 31 is enclosed in a hollow cylinder C (FIG. 4) formed at the heart of at least one blade stage 32a, 32b, 32c, 32d and 32e of the turbine 32. The motor 31 is therefore located inside the tangential-flow turbomachine 30 arranged within the volute 44 and not outside the casing 41, as is the case in the prior art. This arrangement makes it possible to reduce the overall dimensions of the cooling module: placing the motor 31 inside the hollow cylinder C within the turbine 32 makes it possible to save considerable space without compromising the performance of the cooling module.

To facilitate the insertion of the motor 31 inside the hollow cylinder C formed at the heart of the at least one blade stage 32a, 32b, 32c, 32d and 32e of the turbine 32, particular consideration can be given to the case of a cylindrical motor 31 with a longitudinal dimension Lm which is greater than the value of the diameter D of said motor 31. The transverse dimensions of the motor 31 are therefore of a smaller order than its longitudinal dimension Lm.

In the embodiment shown in FIG. 4, the longitudinal dimension Lm of the motor 31 is approximately the same length as the blade stage 32a in which it is arranged. In a non-illustrated embodiment, the longitudinal dimension Lm of the motor 31 may be greater than the length of a turbine blade stage 32. Overall, the longitudinal dimension Lm of the motor 31 is smaller than the lateral dimension of the housing 41 of the cooling module 22. A longitudinal shape of the motor 31 also enables the weight of the motor to be distributed more evenly along the axis of rotation A of the turbine 32 within the volute 44.

In a preferred embodiment of the cooling module shown in FIGS. 2 to 4, the longitudinal axis R of the rotor 312 can coincide with the axis of rotation A of the turbine 32. This coaxiality between the rotor 312 and the turbine 32 facilitates the assembly of these components within the turbomachine 30 during the assembly phase, and prevents the occurrence of unbalance during rotation of the rotor 312 and the turbine 32 around this common axis, thereby limiting the potential for vibrations within the turbomachine 30 that could impair its smooth operation.

In the particular case where the longitudinal axis R of the rotor 312 is not coaxial with the axis of rotation A of the turbine 32, but offset parallel thereto, it is possible to envisage an embodiment of the turbomachine 30 in which the motor output shaft 31 and the turbine 32 are connected by a transmission mechanism, such as a belt or chain system, which is configured to ensure transmission of rotary motion between the motor output shaft 31 and the turbine 32. Since this configuration makes it possible to dispense with the coaxiality requirement, this alternative offers the prospect of a slightly less demanding relative positioning of the turbine 32 and the rotor 312, but on the other hand it can bring additional costs due to the need for a transmission mechanism. This alternative is not shown in the figures.

In addition, at least one blade stage 32a, 32b, 32c, 32d and 32e of the turbine 32 is mechanically connected to the rotor 312 of the motor 31 so that it can be driven in rotation by the latter. To secure the turbine 32 to the rotor 312, the latter can, for example, comprise arms 312a extending radially from the rotor 312 to the turbine 32. In particular, the arms 312a are arranged at regular angular intervals around the axis of rotation A of the turbine 32, as shown in FIG. 3. This makes it possible to ensure a firm connection between the rotor 312 and the turbine 32. In this same figure, the number of arms 312a connecting the rotor 312 to the turbine is six, so the angle separating two adjacent arms 312a is 60°. In a non-illustrated embodiment of the turbine 32, it can cooperate with a rotor 312 comprising four arms 312a, in which case the angle separating two adjacent arms 312a is 90°. More generally, the number of arms 312a between rotor 312 and turbine 32 can be between two and ten. The arms 312a can be integral with the rotor 312 and/or the turbine 32, or these arms 312a can be individual parts which are screwed or glued or welded or otherwise secured to the rotor 312 and turbine 312 at the time of assembly.

The stator 311 of the motor 31 can be fixed to a plate 33 (visible in FIGS. 2 and 4) which is secured to the housing 41. In the example shown in FIGS. 2 to 4, the plate 33 is secured to a side wall 43 of the collector housing 41, so that the motor 31 is arranged at a first end 30a of the turbine 32. The plate 33 is circular in shape, for example, and in particular has a diameter larger than that of the stator 311, so as to increase the intermediate contact surface between the stator 311 and the side wall 43 of the collector housing 41. In particular, the collector housing 41 comprises two side walls 43 substantially perpendicular to the axis of rotation A of the turbine 32, these side walls 43 being arranged in particular at the longitudinal ends of the turbine 32. Fixing the stator 311 to such a plate 33 is an inexpensive solution for arranging the motor 31 within the tangential-flow turbomachine 30.

In addition, the turbine 32 has a second end 30b located opposite the first end 30a. Unlike the first end 30a, which is configured to cooperate with the motor 31 that provides the pivot connection between the collector housing 41 and the turbine 32, this second end 30b comprises a means for forming a direct pivot connection to the collector housing 41. The means for forming said direct pivot connection is, for example, a bearing or a rolling bearing, which can be located in particular inside the collector housing 41, for example on the inner face of the side wall 43 of the collector housing 41. Other means for connecting the second end 30b of the turbine 32 to the collector housing 41, other than bearings, can be envisaged.

The invention is not limited to the embodiments described with reference to the figures, and further embodiments will be clearly apparent to persons skilled in the art. In particular, the various examples can be combined, provided they are not contradictory.

What is claimed is:

1. A cooling module for a motor vehicle with an electric or hybrid motor, configured to have an airflow passing there through and comprising a housing configured to receive a tangential-flow turbomachine itself configured to generate the airflow, the tangential-flow turbomachine including a turbine mounted so as to rotate about an axis of rotation, the turbine including at least one blade stage forming a hollow cylinder, the turbomachine also including a motor configured to drive the turbine in rotation about the axis of rotation, the motor including a stator and a rotor mounted rotatably about the stator, wherein the stator of the motor is secured to the housing so that blades of the at least one blade stage are arranged circumferentially around the rotor of the motor and in that the at least one blade stage of the turbine is mechanically connected to the rotor of the motor so as to be driven in rotation by the latter.

2. The cooling module as claimed in claim 1, wherein a longitudinal axis of the rotor of the motor coincides with the axis of rotation of the turbine.

3. The cooling module as claimed in claim 1, wherein the rotor has radial arms which extend radially from the rotor to the turbine so as to secure the rotor to the turbine.

4. The cooling module as claimed in claim 3, wherein the radial arms connecting the rotor to the turbine are arranged at regular angular intervals around the axis of rotation of the turbine.

5. The cooling module as claimed in claim 1, wherein a longitudinal axis of the rotor of the motor and the axis of rotation of the turbine are offset, and in that an output shaft of the motor and the turbine are connected by a transmission mechanism configured to ensure the transmission of rotary motion between the output shaft of the motor and the turbine.

6. The cooling module as claimed in claim 1, wherein the stator is fixed to a plate secured to a side wall of the housing, so that the motor is located at a first end.

7. The cooling module as claimed in claim 1, wherein a longitudinal dimension of the motor is greater than the value of a diameter of the motor.

8. The cooling module as claimed in claim 1, wherein the turbine has a second end located opposite the first end, and in that this second end has a component configured to form a direct pivot connection to the collector housing.

9. The cooling module as claimed in claim 8, wherein the component configured to form a direct pivot connection to the collector housing is a bearing or a rolling bearing located inside the collector housing.
